(19) United States
(12) Patent Application Publication
(10) Pub. No.: US 2016/0087474 A1
(43) Pub. Date: Mar. 24, 2016

(54) Apparatus, System and Method for Charging a Mobile Device

(71) Applicants: Christian Kellen Tallada, San Diego, CA (US); Angel Mason, San Diego, CA (US); Nick Crouch, San Diego, CA (US)

(72) Inventors: Christian Kellen Tallada, San Diego, CA (US); Angel Mason, San Diego, CA (US); Nick Crouch, San Diego, CA (US)

(21) Appl. No.: 14/835,997

(22) Filed: Aug. 26, 2015

Related U.S. Application Data
(60) Provisional application No. 62/042,065, filed on Aug. 26, 2014.

(51) Int. Cl. H02J 7/00

(52) U.S. Cl. CPC H02J 7/0054; H02J 7/007

(57) ABSTRACT

An apparatus and method for providing electrical charge to a mobile device having a depleted battery from a mobile device having a charged battery via a wired coupling is disclosed. A mobile device may be, inter alia, cellular telephone or a tablet computer.

This U.S. non provisional patent application claims the benefit of priority to earlier filed U.S. provisional patent application entitled, “APPARATUS, SYSTEM AND METHOD FOR CHARGING A MOBILE DEVICE”, filed Aug. 26, 2015, having Ser. No. 62/042,065 and is hereby incorporated by reference in its entirety.

### BACKGROUND

1. Field

The present disclosure generally relates to providing power to a depleted energy storage unit on a mobile device.

2. Related Art

Mobile communications devices, such as for example cellular telephones and tablet computers, have become ubiquitous in modern industrial society. Indeed, with the exponential expansion of available software applications (“apps”) downloadable to such mobile devices the available utility continues to grow. With approximately 2 billion people in the world having access to Internet connectivity, demand for such services continues to accelerate.

In developing countries, simple telephone service can take years to be initiated, largely due to the high cost of the large scale infrastructure associated with embedding copper wires across long distances to carry the electronic signals. A growingly popular substitute for such older methods of providing a population with telephone service has been to build a far less expensive alternative of erecting cellular telephone towers and distributing cellular telephones to subscribers. As this alternative means for providing telephone service to developing nations continues to grow, more of the world's population will have access to telephone service, the Internet and cellular telephones.

One continued limitation of mobile devices, such as tablet computers and cellular telephones is power. Indeed, as more apps and mobile device functionality continue to grow, more power demand is placed on energy storage units of a mobile device, such as for example a battery. Many cellular telephone users have experienced being disconnected from their phone and/or Internet service due to a completely depleted battery. In these circumstances, without a phone charger or a source from which to charge the phone (typically a standard 120 volt AC wall socket or an automobile 12 volt DC supply), the cell phone will be rendered unusable. The present teachings describe a solution for this limitation.

### BRIEF DESCRIPTION OF THE DRAWINGS

Embodiments of the present disclosure will be more readily understood by reference to the following figures, in which like reference numbers and designations indicate like elements.

FIG. 1 illustrates a circuit block diagram for a system for charging a mobile device, according to one embodiment of the present teachings.

FIG. 2 illustrates an apparatus for charging a mobile device, according to one embodiment of the present teachings.

FIG. 3 illustrates a system level block diagram for a system for charging a mobile device, according to one embodiment of the present teachings.

FIG. 4 illustrates a system level block diagram for a system for charging a mobile device directly from an external battery, according to one embodiment of the present teachings.

### DETAILED DESCRIPTION

### Overview

The present teachings disclose a method, apparatus, system and article of manufacture for a power bridge battery charging device. The present disclosure overcomes limitations presented when a mobile device, such as for example a cellular telephone, has a depleted battery. The present teachings disclose how power is transferred through the power bridge battery charger device when charging a battery of a portable device, such as for example, a smartphone or tablet, using power sourced from another portable device, such as for example, another smartphone or another tablet. The present teachings disclose that the power bridge battery charger device may act as a power bridge between cell phone devices. As used herein, “power bridge battery charger device” means a device whereby power flows from a source side to a load side. “Source side” is a device that supplies power for recharging. “Load side” refers to a device to be recharged. The power bridge battery charger device may function as a cell-phone-to-cell-phone power “jump,” which is similar to how a car jump starts another car when a car battery of the another car is dead. In one embodiment, the power bridge battery charger device may work in iPhones.

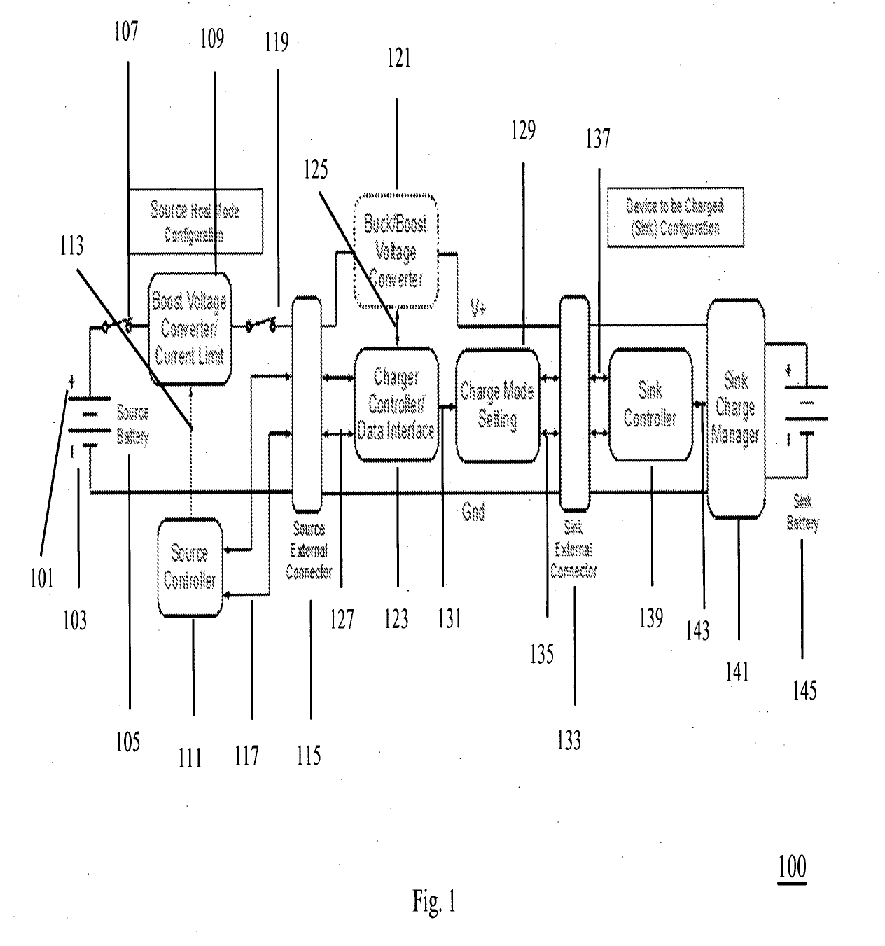

Referring now generally to FIG. 1, one embodiment of a power bridge battery charging device apparatus 100 is disclosed. The power bridge battery charging device apparatus 100 generally comprises a positive terminal 101, a negative terminal 103, a source battery 105, a first switch 107, a boost voltage converter/current limit 109, a source controller 111, a first current flow 113 from the source controller 111 to the boost voltage converter/current limit 109, a source external connector 115, a second current flow 117 to/from the source external connector 115 to/from the source controller, a second switch 119, an optional buck/boost voltage converter 121, a charger controller/data interface 123, a third current current flow 125 to/from the buck/boost voltage converter 121 to/from the charger controller/data interface 123, a fourth current flow 127 to/from the charger controller/data interface 123 to/from the source external connector 115, a charge mode setting 129, a fifth current flow 131 from the charger controller/data interface 123 to the charge mode setting 129, a sink external connector 133, a sixth current flow 135 to/from the sink external connector 133 to/from the charge mode setting 129, a sink controller 139, a seventh current flow 137 to/from the sink controller 139 to/from the sink external connector 133, a sink charge manager 141, a eighth current flow 143 to/from the sink charge manager 141 to/from the sink controller 139, and a sink battery 145.

The positive terminal 101 and the negative terminal 103 are electrical contacts that may be used to connect a load or a charger to a single-cell or a multiple-cell battery. The purpose of the source battery is to 105 provide current to the sink battery 145. When the first switch 107 or the second switch 119 is not touching, this means an open circuit exists with no power flowing. The boost voltage converter/current limit 109 may function as a control for an amount of current. The boost voltage converter/current limit 109 may set the current limit. The source controller 111 may control a boost voltage and may be a microcontroller. In one embodiment, a first current flow 113 may flow from the source controller 111 to the boost voltage converter/current limit 109. The source external connector 115 may serve as a connecting device, such as, for example, a port in a cell phone. The second current flow 117 may flow to/from the source external connector 115 to/from the source controller. In one embodiment of the present teachings, the buck/boost voltage converter 121 may be an optional element. The buck/boost voltage converter 121 may function as a voltage booster. The purpose of the charger controller/data interface 123 may be to control the charger. For example, a charger controller/data interface 123 may be a microprocessor. The third current current flow 125 may flow to/from the buck/boost voltage converter 121 to/from the charger controller/data interface 123. The fourth current flow 127 may flow to/from the charger controller/data interface 123 to/from the source external connector 115. The charge mode setting 129 may allow a user to control a charging rate. For example, the user may set the rate to 100 milliamps or 500 milliamps. The a fifth current flow 131 may flow from the charger controller/data interface 123 to the charge mode setting 129. The sink external connector 133 may be, for example, a microprocessor on a sink cell phone. The sixth current flow 135 may flow to/from the sink external connector 133 to/from the charge mode setting 129. The sink controller 139 may control the flow of current into the sink battery 145. The seventh current flow 137 may flow to/from the sink controller 139 to/from the sink external connector 133. The sink charge manager 141 may be an on-board sink device that controls an amount of current flowing into the sink battery 145.

Voltage regulators are used to provide constant supply voltages to circuits despite variations in a power source and/or in the circuit elements. The voltage regulator is connected between a power source and the circuit it supplies. The voltage regulator includes components to regulate a voltage output by the voltage regulator and to monitor that output voltage for the purpose of regulation. The regulator is designed to provide a constant output voltage, but the output voltage of the regulator may vary if there is a variation in the input from the power source and/or if the circuit being powered draws more or less current at a given time (e.g., as the load varies). As the output voltage varies, the regulator operates to compensate for the variation to provide a constant voltage output.

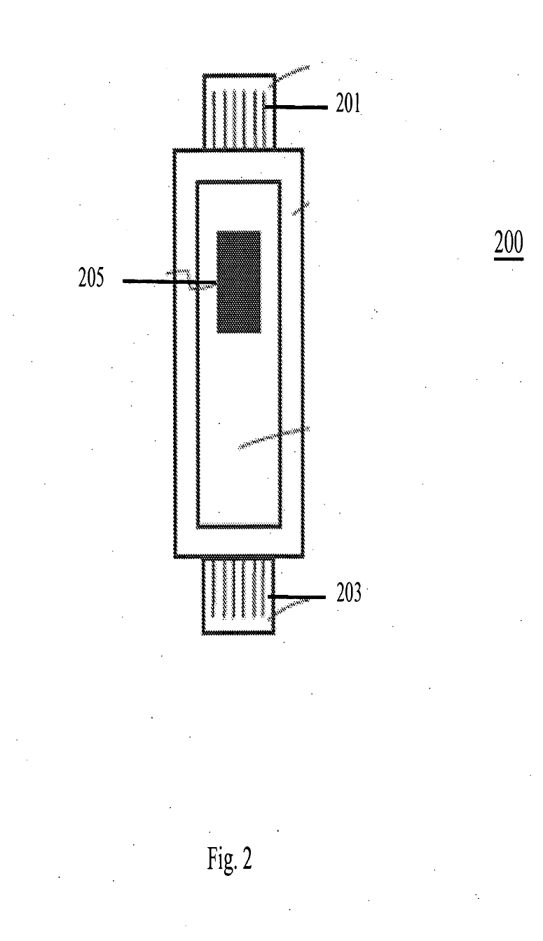

Referring now generally to FIG. 2, one embodiment of a power bridge battery charging device apparatus 200 is disclosed. The power bridge battery charging device apparatus 200 generally comprises a source plug 201, a sink plug 203, and a switch 205. The source plug 201 may plug into a portable device, such as a cell phone, which is a source of voltage or current. The sink plug 203 may plug into a portable device that has to be charged. The switch 205 may function as an on/off button.

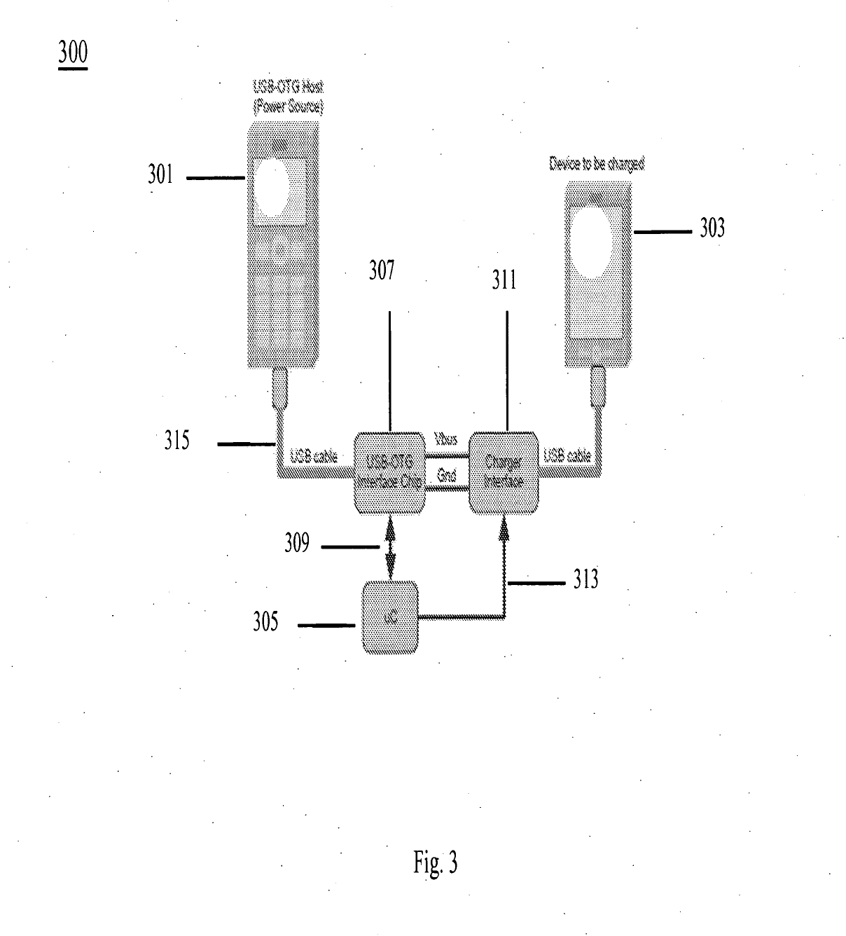

Referring now generally to FIG. 3, one embodiment of a power bridge battery charging device system 300 is disclosed. The power bridge battery charging device system 300 generally comprises a power source 301, a device to be charged 303, a microprocessor 305, a USB-OTG interface chip 307, a first current flow 309 to/from the microprocessor 305 and the USB-OTG interface chip 307, a charger interface 311, a second current flow from the microprocessor 305 to the charger interface 311 , and a USB cable 315. The power source 301 may provide current flow to the device to be charged 303. The microprocessor 305 may handle information to the charger interface 311. The first current flow 309 may flow information to/from the microprocessor 305 and the USB-OTG interface chip 307. The function of the USB-OTG interface chip 307 may be to process information. The USB cable 315 may physically connect the power source 301, the device to be charged 303, the USB-OTG interface chip 307, and the charger interface 311.

In one embodiment, the power bridge battery charger device may function as a key chain accessory. In another embodiment, the power bridge battery charger device may have a bottle opener feature.

The present teachings disclose that the power bridge battery charger device may work with a mobile application to power up a dead phone. In one embodiment, the mobile application may “jump” or power up the dead phone with various levels of charge, for example, 5%, or 10%, or 15%. In one embodiment, the mobile application may have a social media share function. In one embodiment, the mobile application may display a “thank you for your ‘jump’” message at the conclusion of the jump.

In one embodiment of the present teachings, the power bridge battery charger device may be a size of a thumb drive. The thumb drive may be designed for a mobile communications device, such as, for example, an iPhone 5 or a newer version of the iPhone 5. The iPhone 5 and/or the newer version of the iPhone 5 may bridge a physical connection using MFi adapters on both ends. “MFi” means Made for iPhone/iPod/iPad. The purpose of an MFi physical connection may involve sharing and managing battery life between iPhones.

The present teachings disclose that a microchip processor may be used with the power bridge battery charger device. The purpose of using the microchip processor may be to manage battery sharing between two iPhones without use and management of mobile applications. “Microchip processor” means a circuit housed in a chip that handles information according to instructions stored in its memory.

In one embodiment of the present teachings, the power bridge battery charger device may utilize a use and management of the mobile application to manage and share battery life between two iPhones.

In one embodiment, the power bridge battery charger device may have an Android-to-Android version. In another embodiment, the power bridge battery charger device may have an Android-to-iPhone version.

The present teachings disclose that the power bridge battery charger device may be used to share information, such as, for example, pictures, images, documents, videos, and so forth, using proprietary technology from MFi adapters.

As mentioned above, the load side is the portable device to be recharged. Modern portable devices (“PD”) may interact with external devices through a single miniaturized USB (or USB-equivalent) interface, which supports both battery charging and data interaction.

In default mode, the USB port on a PD may act as a slave device, accepting power from an external charge source, such as, for example, a PC/laptop, “wall-wart,” or a car charger. All charge sources provide a voltage between 4.25 and 5.25 volts, per the USB specification. However, current available varies from source to source. For example, a standard USB port on a PC provides a maximum current of 500 milliamps (mA), while a car charger or AC powered charger may deliver greater than 1 ampere (A).

Each PD may control charging of its internal battery with an on-board charge management chip, which sets the current delivered to a battery during the constant-current phase of a recharge cycle. It is generally desirable to recharge the battery in a minimum possible time (using a maximum available current). But since current capacity of charge sources can be different, each charger must have a way of telling a charge management device how much current is available. When a charge source is a PC or other USB Host device, data about current capacity may be provided using regular data protocols. However, as a cost saving measure, dedicated chargers (AC or car chargers) typically do not include a fully functional USB interface device, so an alternative method for indicating current output capacity exists which imposes certain static conditions on USB data lines which differ from a state of the lines when an active device is initially connected to a bus. Thus, a charging input interface to a PD may provide a fairly simple mechanism for interactively adjusting the maximum current provided to the battery.

As mentioned above, the source side means the device supplying power for recharging. Since a PD by default acts as a USB Slave (accepting power and data from an external source), it is necessary to force it to act as a Host instead (providing power and data to external devices). This requirement was anticipated by a USB standards body, which incorporated a substandard called “USB On-the-Go (OTG)” to enable portable devices to act as either a bus controller or slave, depending on what type of device is attached. An OTG standard also modifies USB bus power requirements, enabling a Host-mode PD to manage power availability to external loads to limit impact on battery discharge and operating time.

Although bus voltage requirements are not modified in OTG, current output is limited to 100 mA, maximum, but the Host device is allowed to set a lower current limit to conserve battery power. A minimum current is 8 mA during device enumeration or when the bus is active. An external device attached to the OTG Host port can attempt to request more current from the host, but an actual current limit will vary from device-to-device, depending on both a manufacturer's hardware design and an operating system version, such as, for example, Android, iOS, and so forth.

In one embodiment of the present teachings, a charger system comprises an input cable, a USB micro B 5-pin connector, an ID pin, and a source device (“SD”). The input cable may be terminated in the USB micro B 5-pin connector with the ID pin grounded to put the Source Device (SD) into Host mode.

A USB-OTG interface chip may act as a slave device and may identify itself during enumeration as a very low power peripheral, such as, for example, a self-powered hub, which prevents the host device from shutting down bus power due to an apparent power demand above an 8 mA required by an OTG specification. In one embodiment, more than 8 mA may be available after enumeration is complete, with a true current limit determined by a particular SD design.

A small microprocessor may be used to manage a process of enumeration and negotiation with the host for maximum bus current.

Once the maximum available current is determined and enabled, the microprocessor may configure a charger output interface to indicate maximum charge current available to the device to be charged (the load device, LD), and charging of the LD may begin.

The Host device may monitor a charge state of its battery, shutting down bus power to the external device (charger) to prevent complete discharge. A shutdown threshold may vary from device to device, so an efficacy of the portable-to-portable charger may differ depending on both an initial charge state of an SD battery and the maximum current available in OTG Host mode.

A charger solution described may be a low-rate, or trickle charger. Charge times for an LD battery may be 5 to 100 times longer than even a lowest current (500 mA) existing charge method, assuming an output current range from a proposed device of 5 to 100 mA.

In one embodiment, a specific SD, such as an iPhone, iPad or other equivalent device running an Android OS may be used. A microprocessor may control a slave mode enumeration process, and subsequent negotiation with the SD. Once the maximum available current is determined, the microprocessor may also configure the charger output interface automatically.

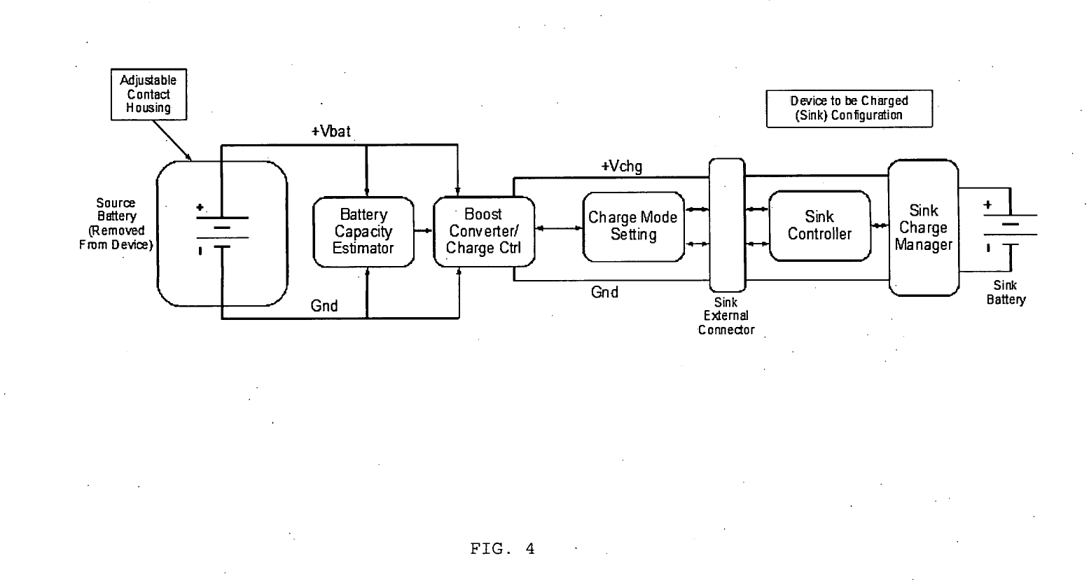

Referring now generally to FIG. 4, one embodiment of a power bridge battery charging device system 400 is disclosed. In this embodiment, a cellular telephone source battery is removed from a source cellular telephone and connected via an adjustable contact housing apparatus. Operation of this embodiment is similar to that described above with reference to FIG. 3, except that in this embodiment, greater access is given to control a specified amount of current drawn to charge a sink battery of a device to be charged.

Those skilled in the art will appreciate that the present teachings may be practiced with other cellular telephone models and other operating systems than those specifically disclosed herein, without departing from the scope and spirit of the present teachings.

Those skilled in the art will appreciate that the present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The computer described herein above may operate in a networked environment using logical connections to one or more remote computers. These logical connections can be achieved using a communication device that is coupled to or be a part of the computer; the present teachings are not limited to a particular type of communications device. The remote computer may be another computer, a server, a router, a network PC, a client, a peer device or other common network node, and typically includes many or all of the elements described above relative to the computer. The logical connections include a local-area network (LAN) and a wide-area network (WAN). Such networking environments are commonplace in office networks, enterprise-wide computer networks, intranets and the Internet, which are all types of networks.

When used in a LAN-networking environment, the computer is connected to the local network through a network interface or adapter, which is one type of communications device. When used in a WAN-networking environment, the computer typically includes a modem, a type of communications device, or any other type of communications device for establishing communications over the wide area network, such as the Internet.

The foregoing description illustrates exemplary implementations, and novel features, of aspects of a power bridge battery charger device and method for charging a battery of a portable device using power sourced from another portable device through the power bridge battery charger device. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising.”

What is claimed is:

1. An apparatus, comprising:
a) a power bridge;
b) a source side; and, c) a load side.

2. The apparatus of claim 1, wherein the power bridge is portable.

3. The apparatus of claim 1, wherein the source side is portable.

4. The apparatus of claim 1, wherein the load side is portable.

5. The apparatus of claim 1, wherein the power bridge facilitates power flow from the source side to the load side.

6. A method for charging a battery, the steps comprising:
a) providing a power bridge;
b) providing a source side; and,
c) providing having a load side.

7. The method of claim 5 wherein the battery is extracted from a portable device.

8. A system, comprising:
a) a power bridge;
b) a source side;
c) a load side, and;
d) means for the power bridge to flow power from the source side to the load side.

9. The system of claim 8, wherein the power bridge is portable.

10. The system of claim 8, wherein the source side is portable.

11. The system of claim 8, wherein the load side is portable.

12. The system of claim 8, wherein the power bridge facilitates power flow from the source side to the load side.
